(19) United States
(12) Patent Application Publication
(10) Pub. No.: US 2017/0011559 A1
(43) Pub. Date: Jan. 12, 2017

(54) PROVIDING INDIVIDUALIZED TOLLS

(71) Applicant: International Business Machines Corporation, Armonk, NY (US)

(72) Inventors: Barry M. Graham, Silver Spring, MD (US); Rick A. Hamilton, II, Charlottesville, VA (US); James R. Kozloski, New Fairfield, CT (US); Scott K. Persky, Fairfax, VA (US)

(21) Appl. No.: 14/794,865

(22) Filed: Jul. 9, 2015

(51) Int. Cl. G07B 15/02; G01C 21/34

(52) U.S. Cl. CPC G07B 15/02; G01C 21/3492

(57) ABSTRACT

A system, method and program product for calculating individualized toll pricing. A method is providing that includes: storing driver data for a set of drivers; providing an objective function for traffic flow in a road network; providing a cost benefit function for each driver in the driver database based on a driver state, future most likely routes, and ability to pay; evaluating the cost benefit function of switching the driver to each possible alternative route, and assigning a cost benefit value to each switch; evaluating the objective function for traffic flow for different scenarios and assigning an impact value to each traffic flow scenario; and calculating an individualized toll incentive for each driver approaching a toll road until the impact value for a current traffic flow scenario meets a predetermined threshold, wherein the individualized toll incentive optimizes the cost benefit value for each driver approaching the toll road.

### TECHNICAL FIELD

The present disclosure relates generally to systems for calculating individualized toll charges for a toll road.

### RELATED ART

Many toll roads use a transponder to collect tolls. Drivers acquire a transponder and mount it on their windshield, and when passing through an electronic toll, the transponder transmits information to a reader mounted on a toll collection point. The transponder usually takes the form of an RFID (Radio Frequency Identification) device although it could also be a cell phone or other device with some type of NFC (Near Field Circuit) or similar technology.

In recent years new types of toll roads have emerged, whereby new toll roads or new lanes are built on existing highways for use by drivers who are willing to pay to use those roads or lanes. A toll is charged via a transponder, which may be variable depending on the time of day, distance or congestion on non-toll roads. The problem with this system is that many drivers are reluctant to pay for a journey that could be free, even if it means saving considerable amounts of time due to less traffic and in some cases increased speed limits.

Some road authorities try to induce drivers into using the new road by eliminating tolls or reducing them for a set period of time. By varying tolls, these authorities are also attempting to smooth traffic so that all roads are priced efficiently (user benefit matches user cost) and the overall traffic network functions efficiently. The problem with this is that such attempts reduce the value of the road, since if too many motorists use the road, there is more traffic and increased likelihood of delays. Also, such promotions only catch those drivers that are present when the promotion is offered.

There are few ways to advertise the new road to new users. One currently used is to offer a trial period where the road access is provided at lower cost or free to everyone. This gets people used to the idea of using the new road with the hope that when the trial period is over, they will continue to use the new road. This only really works if the new road provides substantial savings of time, for example if the road is a brand new route joining roads that were never joined before, or if the road provides new lanes with a higher speed limit than the free lanes.

### SUMMARY

Disclosed is a solution to provide incentives to targeted drivers at any time without making the road free for everyone. This allows the targeting of promotions to those users most likely to achieve the desired traffic smoothing function, without making the road busier and without taking away revenue generated by established customers. It also allows prices to approach the threshold at which a driver will choose a less optimal route.

A first aspect of the disclosure provides a method for calculating individual toll pricing, comprising: storing driver data for a set of drivers in a driver database; providing a communication infrastructure for communicating individualized toll incentives with each driver in the driver database; providing an objective function for traffic flow in a road network; providing a cost benefit function for each driver in the driver database based on a driver state, future most likely routes and ability to pay; measuring a current traffic flow in the road network; for each driver in the road network, evaluating the cost benefit function of switching the driver to each possible alternative route, and assigning a cost benefit value to each switch; evaluating the objective function for traffic flow for different scenarios in which drivers in the road network are switched to different routes, and assigning an impact value to each traffic flow scenario; and calculating an individualized toll incentive for each driver approaching a toll road until the impact value for a current traffic flow scenario meets a predetermined threshold, wherein the individualized toll incentive optimizes the cost benefit value for each driver approaching the toll road.

A second aspect of the disclosure provides a computer program product stored on a computer readable medium, which when executed by a computer system, provides individual toll pricing and comprises: program code for storing driver data for a set of drivers in a driver database; program code for communicating with each driver in the driver database, including communicating individualized toll incentives to each driver; program code for implementing an objective function for traffic flow in a road network; program code for implementing a cost benefit function for each driver in the driver database based on a driver state, future most likely routes, and ability to pay; program code for measuring a current traffic flow in the road network; program code for evaluating the cost benefit function of switching each driver to each alternative route, and assigning a cost benefit value to each switch; program code for evaluating the objective function for traffic flow under different scenarios in which drivers in the road network are switched to different routes, and assigning an impact value to each traffic flow scenario; and program code for calculating an individualized toll incentive for each driver approaching a toll road until the impact value for a current traffic flow scenario meets a predetermined threshold, wherein the individualized toll incentive optimizes the cost benefit value for each driver approaching the toll road.

A third aspect of the disclosure provides a system for calculating individual toll pricing, comprising: a database for storing driver data for a set of drivers; a communication infrastructure for communicating individualized toll incentives to each driver in the driver database; a system for implementing an objective function for traffic flow in a road network and a cost benefit function for each driver in the driver database based on a driver state, future most likely routes, and ability to pay; a system for measuring a current traffic flow in the road network; a system for evaluating the cost benefit function for switching each driver in the road network to each possible alternative route, and assigning a cost benefit value to each switch; a system for evaluating the objective function for different traffic flow scenarios in which drivers in the road network are switched to different routes, and assigning an impact value to each traffic flow scenario; and a system for calculating an individualized toll incentive for each driver approaching a toll road until the impact value for a current traffic flow scenario meets a predetermined threshold, wherein the individualized toll incentive optimizes the cost benefit value for each driver approaching the toll road.

Other aspects of the disclosure provide methods, systems, program products, and methods of using and generating each, which include and/or implement some or all of the actions described herein. The illustrative aspects of the disclosure are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 depicts an illustrative transponder device for displaying rate information for a toll road, according to embodiments.

FIG. 2 depicts a system for communicating toll information, according to embodiments.

FIG. 3 depicts a computing system for implementing a toll pricing system, according to embodiments.

FIG. 4 depicts a flow diagram for implementing a toll pricing model, according to embodiments.

FIG. 5 depicts a road network.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention uses a transponder system to present individualized toll prices to each driver as he or she approaches a toll road option. As described herein, the transponder is also a receiver with an output, such as a digital display, for providing individualized toll pricing. In one embodiment, at a fixed distance before the toll road option, a communication node reads the ID of the transponder, forwards the ID to a toll pricing system which determines and returns a toll rate. As described herein, the individualized toll rate is calculated based on various factors including usage history of the device, number and type of other users of the toll road, etc.

Once calculated, the toll rate is transmitted back to the transponder, where, e.g., it is displayed for the driver to see and decide whether or not to use the toll road. The advantage of this system over current solutions is that the effectiveness of the toll road is not lost by providing a blanket discount for everyone. Such schemes are typically limited time promotions that create the very traffic on the new road that the road was designed to eliminate, thus making it less attractive to those users who try the road during a promotion period. Also by offering targeted discounts and individualized tolls to drivers at all times, revenue is not lost due to a short term blanket change in pricing.

In addition to calculating individualized toll pricing in real-time as a driver approaches a toll road option, such pricing, including discount and/or other toll incentives can alternatively be “pushed” to drivers just in advance of a day's commute (e.g., hours before a planned trip), or may be offered well in advance, e.g., for commitments to follow certain routes for weeks or months, according to desired smoothing effects.

Furthermore, individualized toll pricing information can be collected by an onboard computer in an automobile to make cost-based navigation decisions, e.g., by a navigation system, by an autonomous (i.e., self driving) automobile, etc. In such a case, the user may instruct the system to use toll roads based on predetermined criteria, such as time of day, when the rate meets a personal cost benefit threshold, etc. In response, a navigation system or autonomous automobile would automatically select the toll road when the criteria are met.

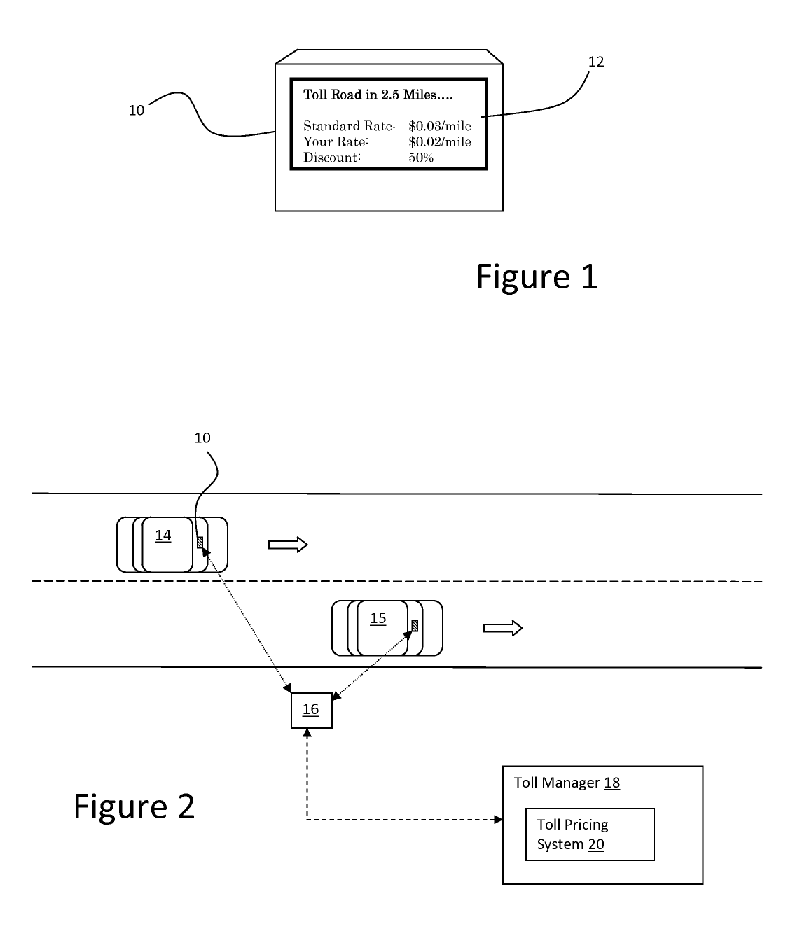

FIGS. 1 and 2 depict an illustrative embodiment. FIG. 1 depicts an illustrative embodiment of a transponder 10 that includes a display 12 that, e.g., alerts the user that a toll road option is approaching, and provides pricing information. In this example, the display 12 shows the standard rate for using the toll road, the individualized rate for the user or automobile associated with the transponder 10, and the percentage discount. Obviously, the format, type and output of the pricing information can vary.

FIG. 2 depicts a system overview showing two automobiles 14, 15 traveling on a highway and entering a “pre-toll road zone.” A pre-toll road zone generally includes a stretch of road prior to a toll road option in which approaching automobiles are detected. In this example, a communication node 16 is placed along the highway prior to an approaching toll road. When the automobiles 14, 15 approach/pass the communication node 16 (i.e., enter a pre-toll road zone), the respective ID's of each transponder 10 is collected and passed to a toll manager 18, which includes a toll pricing system 20. Toll pricing system 20 calculates an individual toll rate for each ID, and returns the rate to the respective transponder 10, where the rate is displayed. The driver can then determine if they want to utilize the toll road. The process is automatically implemented for any automobile that is equipped with a transponder 10. In addition, although not shown, similar communication nodes may collect data: (a) along the toll road itself to track current traffic on the toll road, and (b) along any associated non-toll road(s) to track current traffic along non-toll alternative routes.

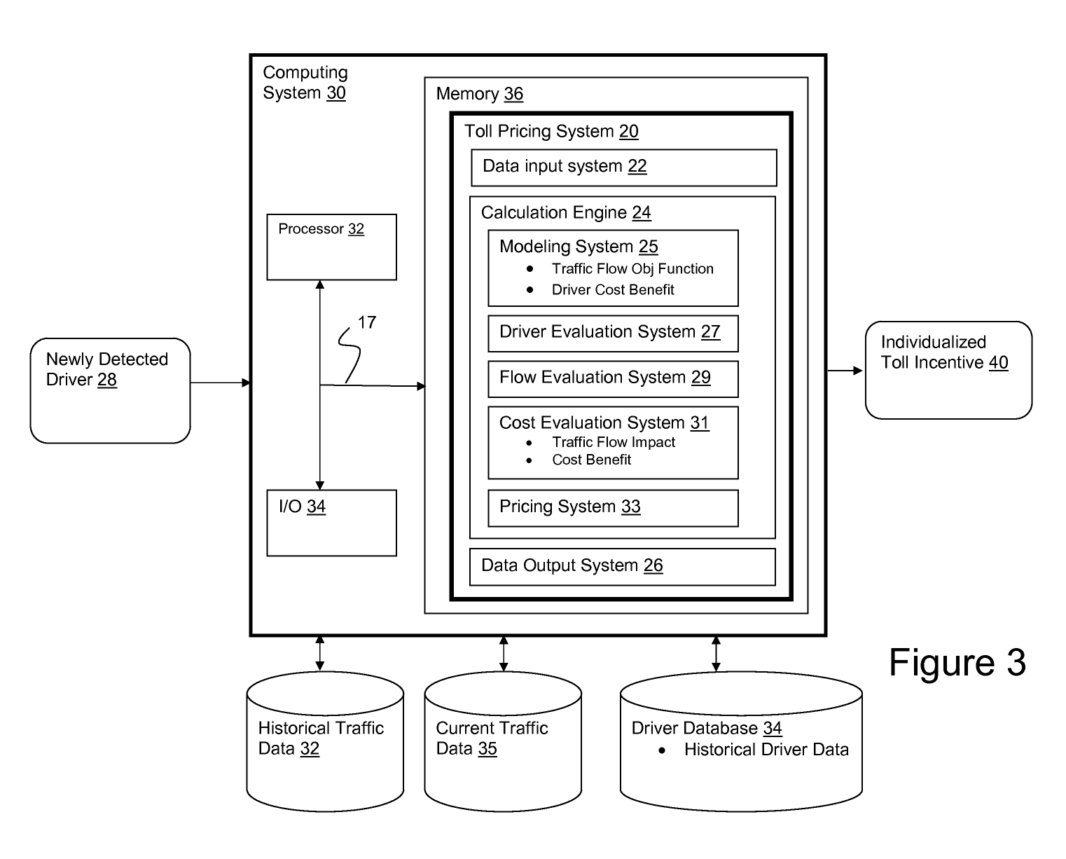

FIG. 3 depicts an illustrative computing system 30 for implementing the present invention. As shown, computing system 30 includes a toll pricing system 20 for a road network that includes: (a) a data input system 22 to receive newly detected driver 28 coming from a detected transponder ID (i.e., driver) approaching a toll road, and to capture current traffic data 35; (b) a calculation engine 24 for calculating an individualized toll incentive 40 for the newly detected driver 28; and (c) a data output system 26 for outputting the individualized toll incentive 40 back to the detected transponder.

Calculation engine 24 generally includes: a modeling system 25 that (a) provides an objective function to, e.g., maximize traffic flow patterns and revenue within a road network based on historical traffic data 32 and (b) provides a cost benefit function for modeling each individual driver from driver database 34 for different routes; a driver evaluation system 27 that evaluates a cost benefit differential for each driver in the road network for each possible route based on current traffic data 35; a flow evaluation system 29 that evaluates the objective function for different traffic flow scenarios based on current traffic data 35; a cost evaluation system 31 that (a) assigns a “impact” value for improvement of traffic flow for switching each current driver in the road network to each possible alternative route, and (b) assigns a “cost benefit” value to each driver in the network for cost versus benefit for switching to each new route; and a pricing system 33 that calculates a discount or incentive to drivers to offset increased cost over increased benefit until the monetary value of the traffic flow impact is dispersed.

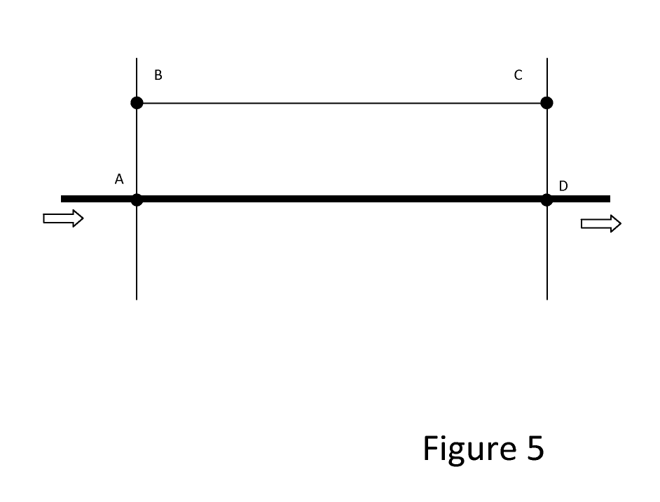

The objective function provided by modeling system 25 generally provides a mathematical model to, e.g., maximize or optimize traffic flow efficiency and revenue in a road network. For example, FIG. 5 depicts a road network in which drivers can proceed (1) along free roadways via nodes A-B-C-D; or (2) along a toll roadway via nodes A-D. An objective function ƒ_{T} may for example model flow over different time periods T along two routes R₁ and R₂. E.g.,

ƒ_{T}(aR₁,bR₂),

where a, b represent volume of traffic along each route. It is understood that the specific form of the objective function can vary and the above is given for illustrative purposes only. The objective function ƒ_{T} may for example be implemented as an optimization problem that seeks to maximize the greatest revenue from the toll road taking into account the number of cars using different routes, speed along different routes, etc. ƒ_{T} may be implemented as a quadratic loss function, a density estimation function, etc. Regardless of the form, the objective function will seek to solve for an ideal percentage or volume of traffic along each route to, e.g., maximize the total number of drivers or revenue along a toll road without adversely impacting traffic flow on the toll road.

The cost benefit function provided by modeling system 25 may be implemented as a function F that can be applied to each driver D in the driver database 34 for taking different routes in a road network given an analysis of the driver's state S, future most likely routes L, and ability to pay P. E.g.,

F(D)=w₁S+w₂L+w₃P,

where w₁, w₂ and w₃ are weights or operators that, e.g., covert a collected value into a cost benefit measure. It is understood that the cost benefit function may take any form, and the above is provided for illustrative purposes. Regardless, a high cost benefit result may indicate that a driver is more willing to pay for a toll road, whereas a low cost benefit result may indicate that the driver is less likely to pay for the same toll road. The driver's state S may comprise any measurable or combination of measurables that describes the driver, for example, the speed of the driver (indicating whether the driver prefers to move fast), the typical arrival time of the drive at a toll road (indicating that the driver is later or early), whether the driver is likely to be using the route for work or pleasure (e.g., a driver on vacation may be more likely to pay for a faster route than a driver getting paid by the hour), the type of car, etc. Future most likely routes L and ability to pay P may be, for example, ascertained from historical driver data in the driver database 34. Regardless, the cost benefit function is driver dependent, such that each driver in the driver database 34 can be analyzed to reflect a willingness to pay for a driving benefit.

The driver evaluation system 27 determines, for each driver on the toll road, the cost benefit of switching to each possible alternate route, based on the current traffic data 32. Thus, the following situations may apply:

1) if there is little traffic on each route, the cost benefit of switching from a free road to a toll road will generally only be significant for a few drivers;

2) if there is little traffic on the toll road and a lot of traffic on the free road, the cost benefit of switching from the free road to a toll road will generally be significant for most drivers;

3) if there is medium traffic on each road, the cost benefit of switching from the free road to a toll road will be mixed; etc.

Flow evaluation system 29 evaluates the impact on the objective function for different scenarios of switching each driver to each different route based on current traffic data. Thus for example, if 100 current drivers were to switch from a free road to a toll road, the objective function impact value may be increased due to the increased revenue. However, having 1000 drivers switch may result in a decreased objective function impact value due to the slowing of the traffic flow on the toll road.

Cost evaluation system 31 assigns a monetary value for improvement to traffic flow (i.e., traffic flow impact) for each such scenario evaluated by flow evaluation system 29. Thus for instance, if 100 drivers were to switch to a toll road, the dollar value of improvement may be $500, i.e., increased revenue without any impact on traffic flow. Conversely, if 1000 drivers were to switch to a toll road, the dollar value of improvement may be −$500 due to the impact on traffic flow. Cost evaluation system 31 also assigns a monetary (i.e., cost benefit) value for increased cost over increased benefit for each driver approaching a toll road option. For example, the cost for a driver switching to a toll road may be high relative to the benefit (i.e., a low cost benefit because only a small amount of time will be saved in exchange for paying the standard toll rate).

Pricing system 33 provides a discount or other incentive to drivers approaching a toll road option to offset increased cost over increased benefit until the monetary value of the societal benefit is dispersed. In other words, discounts will be provided to drivers (based on each individual driver's cost benefit function) until the traffic flow impact value crosses some threshold, e.g., becomes negative.

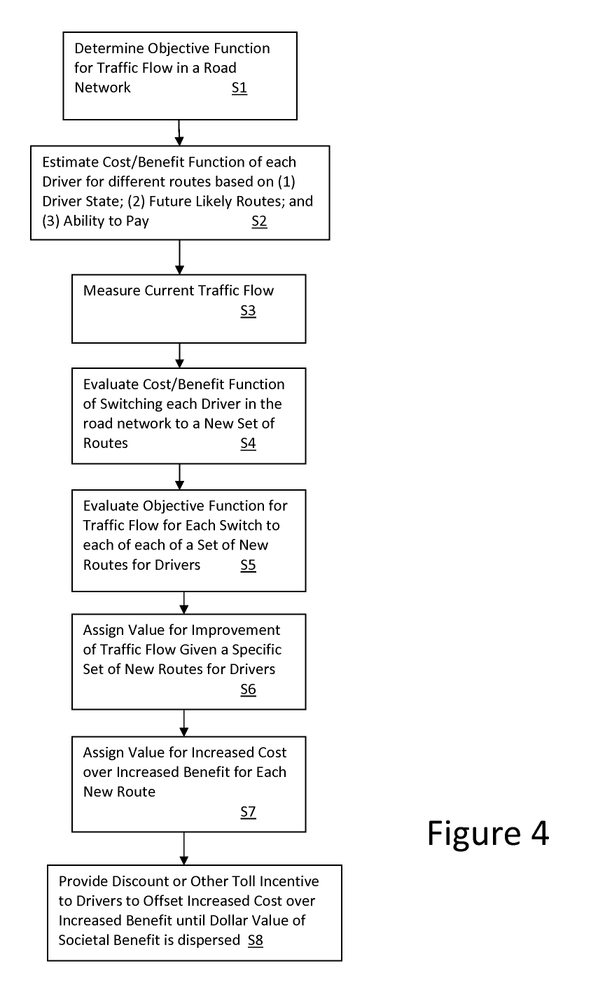

FIG. 4 depicts an illustrative process for implementing a pricing model. At S1, an objective function for traffic flow in a road network is determined. Next, at S2, a cost/benefit function of each driver for different routes is estimated given an analysis of driver state, future most likely routes, and ability to pay. The driver state may for example include the speed at which the driver is moving, time of day, etc. Future most likely routes may for example be based on historical routes taken by the driver. Ability to pay may for example be based on historical data, automobile make, etc.

At S3, the current traffic flow is measured, and at S4, the cost/benefit function for switching each driver in the road network to each of a set of alternate routes is evaluated. At S5, the objective function for traffic flow for each switch to each of set of new routes for each driver is evaluated. At S6, a value (i.e., traffic flow impact) for improvement of traffic flow for different scenarios of new routes for different drivers is determined. At S7, a cost benefit value is assigned for increased cost over increased benefit for each new route for drivers approaching a toll road. Finally, at S8, a discount or other toll incentive is provided to drivers to offset increased cost over increased benefit until dollar value of societal benefit is dispersed.

Three alternative pricing models are described as follows for calculation engine 24 (FIG. 3). Each of the models may utilize current traffic data 32 that details all of the current traffic in the pre-toll road zone, in the toll road itself, and non-toll road alternative routes, as well a historical driver data that details information about all drivers having an associated transponder. Depending on the implementation, calculation engine 24 may be implemented with any one or more of the models.

### Driver-Based System

The first approach calculates an individualized toll rate according to route switching costs.

1. Estimate a cost benefit function for each driver as described herein based on an analysis of a driver's state, future most likely routes, and ability to pay.

2. Estimate a cost benefit function for switching each driver to each of a set of new routes.

3. Assign impact on traffic flow given specific set of new routes for drivers.

4. Increase toll on current route and offer promotion for alternate route to those drivers with highest route switching cost and for which switching provides greatest positive impact on traffic flow.

5. Repeat iteration until predicted traffic flow benefit from additional switching is minimized.

### Usage Based System

This approach takes into account the fact that different drivers have a different impact on a road, and its value to current users of the road. Therefore, promoting road usage for some drivers may have a different (negative) impact on traffic flow patterns, road safety, quality of driving experience, and therefore future road utilization than promoting road usage to other drivers.

This approach creates better pricing for tolls in a traffic flow control system by targeting promotions, tolls, and incentives to individual drivers according to their expected impact on existing drivers and road conditions. Expectation is calculated based on historical driving data. The steps include:

1. Estimate cost benefit function of each existing driver on a route for another driver switching to that route, given analysis of driver historical data.
2. Estimate cost benefit function of switching for each driver to each of a set of new routes.
3. Increase toll on current route and offer promotion for alternate route to those drivers with lowest route switching cost to other drivers and for which switching provides greatest positive impact on current driver.
4. Repeat iteration until predicted impact on other drivers reaches a negative threshold or additional benefit to driver is minimized.

### Impact Based

This approach creates better pricing for tolls to encourage adoption of new routes by drivers and improve traffic flow by targeting promotions, tolls, and incentives to individual drivers according to their expected impact on road conditions, and their expected cognitive switching cost. Expected switching cost is calculated based on historical driving data and cognitive profile. The steps include:

1. Estimate cost benefit to traffic when switching an existing driver from one route to another.
2. Estimate cost of switching for each driver to each of a set of new routes based on an estimate of driver's willingness to switch and cognitive profile using historical driving data.
3. Increase toll on existing route and offer promotion for alternate route to those drivers with highest cognitive cost of switching route and for which switching provides greatest positive impact overall traffic flow objective.

Note that the cognitive cost of switching is a well documented phenomenon (http://en.wikipedia.org/wiki/Switching_barriers), and include search costs, learning costs, cognitive effort, emotional costs, psychological risk, and social risk. A good example is a driver who has used a single route for a commute over a period of years. The perceived cost of switching this route is compounded by the driver's familiarity and associations with this route. Such a driver may therefore require a higher incentive to switch than a driver who has only been using the route for a few months.

Referring again to FIG. 3, computing system 30 may comprise any type of computing device and, and for example includes at least one processor 32, memory 36, an input/output (I/O) 34 (e.g., one or more I/O interfaces and/or devices), and a communications pathway 17. In general, processor(s) 32 execute program code for implementing a toll pricing system 20 of the present invention, which is at least partially fixed in memory. While executing program code, processor(s) 32 can process data, which can result in reading and/or writing transformed data from/to memory 36 and/or I/O 34 for further processing. The pathway 17 provides a communications link between each of the components in computing system 30. I/O 34 may comprise one or more human I/O devices, which enable a user to interact with computing system 30.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A method for calculating individual toll pricing, comprising:
storing driver data for a set of drivers in a driver database;
providing a communication infrastructure for communicating individualized toll incentives with each driver in the driver database;
providing an objective function for traffic flow in a road network;
providing a cost benefit function for each driver in the driver database based on a driver state, future most likely routes and ability to pay;
measuring a current traffic flow in the road network;
for each driver in the road network, evaluating the cost benefit function of switching the driver to each possible alternative route, and assigning a cost benefit value to each switch;
evaluating the objective function for traffic flow for different scenarios in which drivers in the road network are switched to different routes, and assigning an impact value to each traffic flow scenario; and
calculating an individualized toll incentive for each driver approaching a toll road until the impact value for a current traffic flow scenario meets a predetermined threshold, wherein the individualized toll incentive optimizes the cost benefit value for each driver approaching the toll road.

2. The method of claim 1, wherein the communication infrastructure comprises a plurality of transponders, each associated with a unique driver.

3. The method of claim 2, wherein the transponder includes a visual readout that displays the individualized toll incentive.

4. The method of claim 1, wherein the objective function maximizes traffic flow efficiency and revenue in the road network.

5. The method of claim 1, wherein the cost benefit value and impact value each comprise a monetary value.

6. The method of claim 1, wherein the driver state is determined by analyzing at least one of: a speed of the driver, whether the driver is early or late, whether the driver is traveling for work or pleasure, and a type of automobile being used by the driver.

7. The method of claim 1, wherein the future most likely routes, and ability to pay are determined from historical data associated with the driver.

8. A computer program product stored on a computer readable medium, which when executed by a computer system, provides individual toll pricing and comprises:
program code for storing driver data for a set of drivers in a driver database;
program code for communicating with each driver in the driver database, including communicating individualized toll incentives to each driver;
program code for implementing an objective function for traffic flow in a road network;
program code for implementing a cost benefit function for each driver in the driver database based on a driver state, future most likely routes, and ability to pay;
program code for measuring a current traffic flow in the road network;
program code for evaluating the cost benefit function of switching each driver to each alternative route, and assigning a cost benefit value to each switch;
program code for evaluating the objective function for traffic flow under different scenarios in which drivers in the road network are switched to different routes, and assigning an impact value to each traffic flow scenario; and
program code for calculating an individualized toll incentive for each driver approaching a toll road until the impact value for a current traffic flow scenario meets a predetermined threshold, wherein the individualized toll incentive optimizes the cost benefit value for each driver approaching the toll road.

9. The program product of claim 8, wherein program code for communicating with each driver comprises program code for sending data to a plurality of transponders, each associated with a unique driver.

10. The program product of claim 8, wherein the objective function maximizes traffic flow efficiency and revenue in the road network.

11. The program product of claim 8, wherein the cost benefit value and impact value each comprise a monetary value.

12. The program product of claim 8, wherein the driver state is determined by analyzing at least one of: a speed of the driver, whether the driver is early or late, whether the driver is traveling for work or pleasure, and a type of automobile being used by the driver.

13. The program product of claim 8, wherein the future most likely routes and ability to pay are determined from historical data associated with the driver.

14. A system for calculating individual toll pricing, comprising:
a database for storing driver data for a set of drivers;
a communication infrastructure for communicating individualized toll incentives to each driver in the driver database;
a system for implementing an objective function for traffic flow in a road network and a cost benefit function for each driver in the driver database based on a driver state, future most likely routes, and ability to pay;
a system for measuring a current traffic flow in the road network;
a system for evaluating the cost benefit function for switching each driver in the road network to each possible alternative route, and assigning a cost benefit value to each switch;
a system for evaluating the objective function for different traffic flow scenarios in which drivers in the road network are switched to different routes, and assigning an impact value to each traffic flow scenario; and
a system for calculating an individualized toll incentive for each driver approaching a toll road until the impact value for a current traffic flow scenario meets a predetermined threshold, wherein the individualized toll incentive optimizes the cost benefit value for each driver approaching the toll road.

15. The system of claim 14, wherein the communication infrastructure comprises a plurality of transponders, each associated with a unique driver.

16. The system of claim 15, wherein each transponder includes a visual readout that displays the individualized toll incentive.

17. The system of claim 14, wherein the objective function maximizes traffic flow efficiency and revenue in the road network.

18. The system of claim 14, wherein the cost benefit value and impact value each comprise a monetary value.

19. The system of claim 14, wherein the driver state is determined by analyzing at least one of: a speed of the driver, whether the driver is early or late, whether the driver is traveling for work or pleasure, and a type of automobile being used by the driver.

20. The system of claim 14, wherein the future most likely routes, and ability to pay are determined from historical data associated with the driver.
